(19) United States
(12) Patent Application Publication
(10) Pub. No.: US 2009/0052187 A1
(43) Pub. Date: Feb. 26, 2009

(54) Heat-Dissipating Lighting System

(76) Inventor: Weiping Li, Fremont, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/844,992

(22) Filed: Aug. 24, 2007

(51) Int. Cl. F21V 29/00; F28D 7/00

(52) U.S. Cl. 362/294; 165/164

(57) ABSTRACT

The heat dissipating lighting system includes a closed-loop coolant path with a warmed fluid channel and a cooled fluid channel. The outlet of the warmed fluid channel is in fluid communication with the inlet of the cooled fluid channel and vice versa. Substantial portions of the warmed and cooled fluid channels are thermally isolated from one another. A light source is thermally connected to the coolant path along the warmed fluid channel, near the warmed fluid inlet.

### BACKGROUND

(a) Field of the Invention

The present invention relates to a lighting system that dissipates heat from a light source.

(b) Description of the Related Art

Conventional indoor and outdoor lighting systems utilize incandescent, fluorescent, or high-intensity discharge (HID) light sources. Recently, significant efforts have been made to develop white light-emitting diodes (LEDs) for lighting system applications. It is widely expected that LEDs will be the next generation of light source. However, unlike conventional light sources, which can operate at several hundred degrees Celsius, LEDs cannot operate at temperatures above around 85° C. It is therefore desirable to provide a lighting system that can dissipate the heat generated by LEDs, and maintain the LEDs at their optimum temperature.

### SUMMARY

A lighting system includes a light source attached to a coolant chamber, the chamber being defined by an outer and an inner wall. The coolant chamber defines a closed-loop coolant path with an upward, or warmed, coolant channel; and a downward, or cooled, coolant channel, separated by the inner wall.

Coolant is allowed to flow through the coolant chamber by natural convection. To this end, the light source may be disposed at a lower side surface of the chamber. Coolant near the light source absorbs heat from the light source, and moves upward along the warmed coolant channel by natural convection. Once the coolant at the upper portion of the chamber has cooled, it moves generally downwards along the cooled coolant path, also by natural convection.

A radiator may additionally be provided at a higher side surface of the coolant chamber, opposite the light source. A sun-shield may also be provided to shield the radiator and/or at least a portion of the chamber from the sun.

A volume change compensation device may also be provided. The device may be a vent, a deformable patch, or a bellows, on the surface of the coolant chamber.

### BRIEF DESCRIPTION OF THE DRAWINGS

FIG. 1 is a partial schematic cross-sectional view of a first exemplary embodiment of a lighting system;

FIG. 2 is a partial schematic cross-sectional view of a second exemplary embodiment of a lighting system;

FIG. 3 is a partially schematic, cross-sectional view of a lighting system according to exemplary embodiments, indicating the portion of the system shown in detail in FIGS. 3A-3C;

FIG. 3A is an enlarged partial view of FIG. 3, illustrating a first exemplary embodiment of a volume change compensation device;

FIG. 3B is an enlarged partial view of FIG. 3, illustrating a second exemplary embodiment of a volume change compensation device; and

FIG. 3C is an enlarged partial view of FIG. 3, illustrating a third exemplary embodiment of a volume change compensation device.

Like reference numerals refer to corresponding parts throughout the several views of the drawings.

### DETAILED DESCRIPTION OF SOME EMBODIMENTS

Recent breakthroughs have increased the brightness of light-emitting diodes (LEDs), making them candidates for light sources for high-intensity lighting systems, such as indoor and outdoor lighting, streetlamps, stadium lights, etc.

LEDs also provide several advantages over traditional light sources. First, they are longer lasting: currently, LEDs can last for 20,000-50,000 hours, and it is contemplated that their lifetime will exceed 50,000 hours in the future. Second, they are more efficient: the theoretical luminous efficacy of white LEDs is over 400 lumens/Watt (lm/W), and LEDs with luminous efficacies of 150 lm/W are already being manufactured. (For comparison, luminous efficacies of traditional light sources are about 5-35 lm/W for incandescent lights, about 45-100 lm/W for fluorescent lights, and about 150-200 lm/W for HID lights.) Third, LEDs are environmentally friendly or “green” light sources: they are lead-, halogen-, and mercury-free, and, unlike fluorescent lights, do not emit any ultra-violet light, which is harsh and potentially harmful.

While LEDs are currently more expensive than traditional light sources, their cost is ever decreasing, and it is contemplated that within a few years, they will be competitively priced. LEDs are therefore good candidates for light sources.

However, as mentioned above, LEDs typically cannot operate at temperatures over about 85° C. This means that they need to be cooled in many lighting systems, especially because, at their optimum temperatures, the temperature difference between the LED and the ambient air can sometimes be quite small, therefore making it difficult to transfer heat from the LEDs to the surrounding air. A simple, cheap, easily maintained thermal dissipation path is therefore necessary.

Some of the embodiments described herein provide a heat-dissipating lighting system that can effectively remove heat from a light source by natural convection, i.e. without the need for any machinery, such as fans or pumps, which use electricity and thereby decrease the efficiency of the light source.

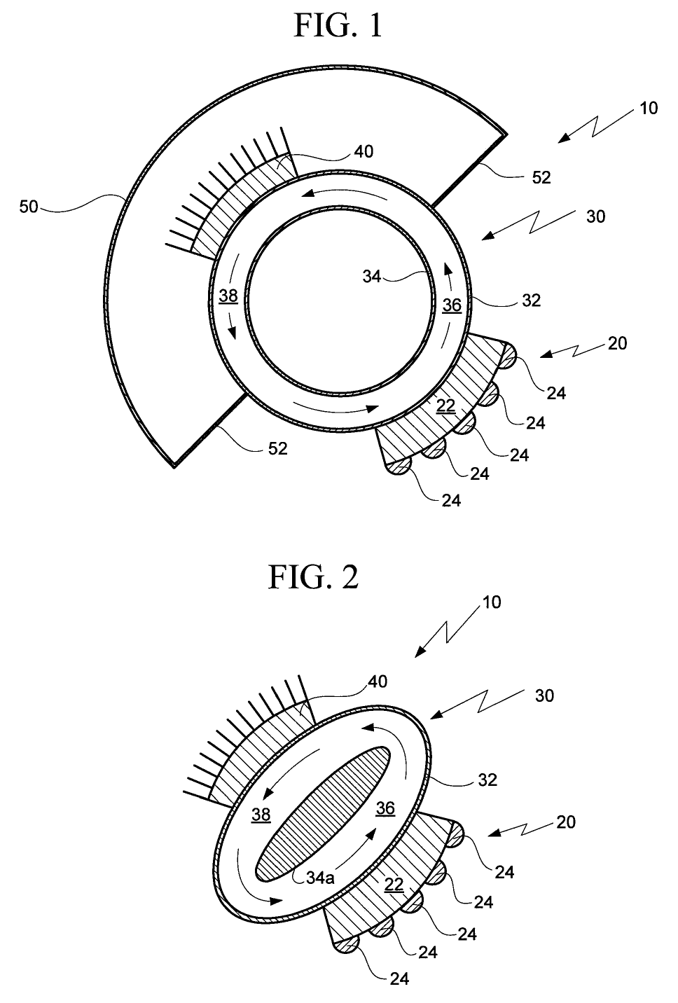

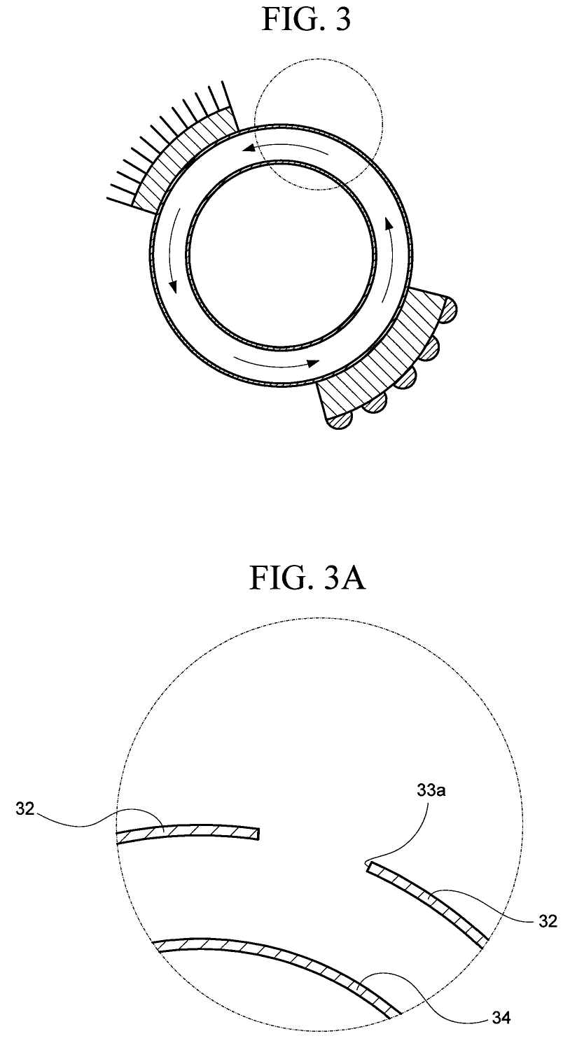

Referring to FIGS. 1 and 2, in some embodiments, a lighting system 10 includes a light source 20, such as a light fixture 22 housing light bulbs or LEDs 24. In some embodiments, the light source 20 is attached to a coolant chamber 30, defined by an outer wall 32 and an inner wall 34, 34a. The coolant chamber 30 defines a closed-loop coolant path having an upward, or warmed, coolant channel 36; and a downward, or cooled, coolant channel 38. The lighting system 10 may also include a radiator 40 (otherwise known as a heat sink or heat spreader), attached to the chamber 30; and/or a sun-shield 50, to block at least a portion of the system 10 from the sun.

The light source 20 is thermally coupled to the chamber 30. In the illustrated embodiments, the light bulbs or LEDs 24 are housed in a thermally conductive light fixture 22, which is, in turn, attached to the chamber 30. However, in some embodiments, a separate light fixture 22 may not be necessary, as the chamber may include the fixture. These embodiments could be accomplished, for example, by attaching the bulbs or LEDS 24 directly to a fixture integral with the chamber wall 34.

In some embodiments, the chamber 30 houses coolant (designated by arrows in the figures). In some embodiments, the coolant is allowed to flow through the coolant chamber by natural convection alone, i.e. without fans, pumps, etc. In other words, thermal currents in the coolant are such that the coolant moves in a predetermined path around the chamber (anti-clockwise in the figures). To this end, in some embodiments, the light source 20 is disposed at a lower side surface of the chamber 30, e.g. at the 4 to 5 o'clock position shown in the figures. In operation, coolant near the light source 20 absorbs heat from the light source 20, and rises by natural convection in the direction of the arrow 36. Warmed coolant moves generally upwards within the warmed coolant path 36, and once the coolant has been cooled, such as by transferring the absorbed heat to the radiator 40, it moves generally downwards within the cooled coolant path 38.

Because, in some embodiments, the light source 20 is near the bottom and to one side (offset lower side) of the chamber 30, the coolant that is warmed by the light source 20 cannot flow backwards, i.e. in the direction opposite the arrows. For example, if the light source 20 were to be disposed at the exact bottom of the chamber 30, the coolant would be able to flow upwards along both coolant paths 36, 38, and the circular or oval flow path shown by the arrows could not be accomplished by natural convection. In some embodiments, the location of the light source 20 at the offset lower side of the chamber 30, as illustrated, allows natural convection alone to move the coolant in the generally circular or oval paths illustrated.

It should be understood that while the illustrated offset lower side placement of the light source 20 and associated lack of fans or pumps is currently considered advantageous from a cost and simplicity standpoint, the claimed invention is not limited thereto.

As mentioned above, the coolant chamber 30 may be defined by an outer wall 32 and an inner wall 34, 34a. Depending on the particular application of the lighting system 10, the walls 32, 34, 34a may be made of thermally conducting and/or thermally insulating materials.

For example, it will be appreciated that to maintain natural convection, the two coolant paths 36, 38 should advantageously be fluidly and thermally isolated from one another. Depending on size, material, and other constraints, this may, in some embodiments, be accomplished by a hollow inner wall 34, such as that illustrated in FIG. 1, providing an air or other gap between the two paths 36 and 38. It could additionally or alternatively be accomplished by the hollow inner wall 34 (FIG. 1) or solid inner wall 34a (FIG. 2) being made of thermally insulating material.

Similarly, the outer wall 32 can be designed to have any appropriate thermal characteristics depending on the application. For example, in some embodiments, the entirety of the outer wall 32 is thermally conductive. In other embodiments, the portion of the outer wall 32 in thermal contact with the light source 20 and/or the radiator 40 is thermally conductive, while at least another portion of the outer wall 32 is thermally insulating. In further embodiments, such as those for use in particularly hot climates, the heated coolant channel 36 has a thermally conducting wall 32 or walls 32, 34, and the cooled coolant channel 38 has an insulating wall 32 or walls 32, 34 except for the portion in contact with the radiator 40. These embodiments may be particularly useful when a radiator 40 is included, as will be described below, and prevent the coolant cooled by the radiator 40 from being heated by the ambient air before returning to the portion of the chamber 30 near the light source 20.

The walls 32, 34, 34a may be made of any material with the appropriate structural and thermal characteristics, depending on the application. Some suitable materials are, without limitation: copper, aluminum, alloys thereof, and stainless steel.

In some embodiments, as mentioned above, a radiator 40 is further provided. In some embodiments, the radiator 40 is thermally coupled to the chamber 30 at an upper and to one side (offset upper side) surface of the chamber 30. In some embodiments, a major portion of the heat dissipation from the system 10 occurs at the radiator 40. Therefore, the coolant near the radiator 40 may experience a rapid temperature drop, causing it to sink by natural convection along path 38. For reasons discussed above regarding the placement of the light source 20, it may therefore be advantageous for the radiator to be disposed at the offset upper side of the coolant chamber 30. In some embodiments, the radiator 40 is disposed opposite the light source 20.

It should be appreciated that the radiator 40 is illustrated schematically for simplicity. The radiator 40 can be any radiator, heat sink, heat spreader, or any other element that dissipates heat from the system 10, and can be designed and implemented by a person of ordinary skill in the art based on the teachings herein.

In operation, in some embodiments, the coolant is heated at the bottom right of the figures, causing it to flow generally upwards along channel 36 as indicated by the arrows. Once the coolant reaches the radiator 40, it begins to cool, and flows generally downwards along channel 38 back toward the light source 20. As mentioned above, the light source 20 can thus be constantly cooled by the natural convection of the coolant and the radiator 40, without the need for fans or pumps.

In some applications, such as, for example, for outdoor lighting, it is advantageous to further provide a sun-shield 50. The sun-shield 50 may be made of insulating or reflective material, and may shield the radiator 40, and/or at least a portion of the chamber 30, from the sun. The sun-shield 50 may be attached to the chamber 30 with mounting brackets 52, which may be made of thermal insulators. Alternatively, the sun-shield 50 may be mounted to any structural element, such as a lamp-post (not shown).

In some embodiments, the portion of the chamber 30 and/or the radiator 40 that is shielded by the sun-shield 50 is in thermal and/or fluid communication with the atmosphere. For example, in the embodiment illustrated in FIG. 1, ambient air is able to flow freely in the direction into and out of the page, as well as between the mounts 52 in the direction perpendicular to the mounts 52.

It should be appreciated that FIGS. 1 and 2 are provided to illustrate some features of embodiments described herein and should not be considered mutually exclusive. For example, the circular chamber 30 shown in FIG. 1 could have a solid inner wall 34a, or the oval chamber 30 shown in FIG. 2 could have a hollow inner wall 34. Likewise, the sun-shield 50 is omitted from FIG. 2 for simplicity, but could optionally be included regardless of the shape of the chamber 30 or inner wall 34, 34a.

The coolant disposed in the chamber 30 may be any suitable fluid, such as, without limitation: water, deionized water, ethylene glycol, diethylene glycol, propylene glycol, mineral oil, castor oil, silicone oil, or fluorocarbon oil.

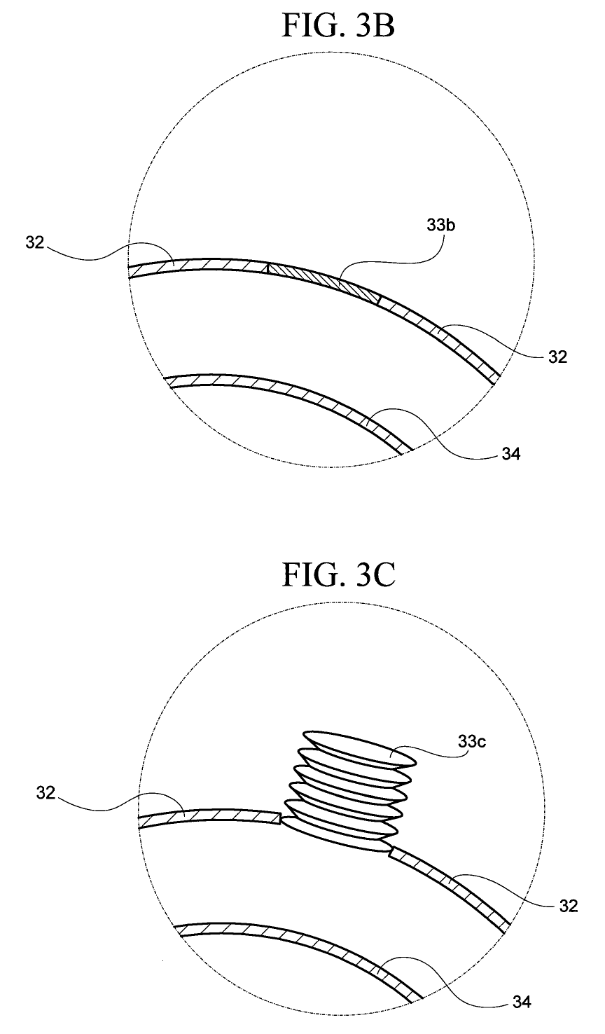

Turning now to FIGS. 3-3C, it will be appreciated that in some applications, depending on environment and the like, the total volume of the coolant will fluctuate a considerable amount as it heats and cools, depending on the coolant used. In some embodiments, the chamber 30 is made, in whole or in part, of a material flexible enough to compensate for this volume change. In some embodiments, a volume change compensation device 33a, 33b, 33c is provided. FIGS. 3A-3C are enlarged views of the portion of the chamber 30 indicated in FIG. 3. Each of FIG. 3A-3C illustrates one embodiment of a volume change compensation device. It should be appreciated that the location of the volume change compensation device can be changed based on design considerations, but it should advantageously be in fluid communication with the coolant within the chamber 30.

FIG. 3A illustrates an open vent 33a. When the coolant within the chamber 30 expands beyond a certain tolerance, it overflows out of the vent 33a.

FIG. 3B illustrates a patch 33b. The patch may be made of a material that is more deformable than the remainder of the chamber 30, such as soft rubber. When the coolant expands, it stretches the patch 33b outwards.

FIG. 3C illustrates a bellows 33c. When the coolant expands, it stretches the bellows 33c outwards. The bellows 33c may be made of any suitable material.

Alternatively, the chamber wall may be made sufficiently strong to withstand any expansion of fluid.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A heat dissipating lighting system, comprising:
a closed-loop coolant path, comprising:
a warmed fluid channel having a warmed fluid inlet and a warmed fluid outlet; and
a cooled fluid channel having a cooled fluid inlet and a cooled fluid outlet, wherein the warmed fluid outlet is in fluid communication with the cooled fluid inlet, and the cooled fluid outlet is in fluid communication with the warmed fluid inlet, and wherein the warmed fluid channel and the cooled fluid channel are substantially thermally isolated from one another along substantial portions thereof; and
a light source, thermally connected to the coolant path along the warmed fluid channel, near the warmed fluid inlet.

2. The system of claim 1, wherein, in use, that the cooled fluid outlet is below the warmed fluid inlet, and the warmed fluid outlet is above the cooled fluid inlet.

3. The system of claim 1, wherein the coolant path comprises a substantially oval or elliptical path.

4. The system of claim 3, wherein the coolant path comprises a substantially circular path.

5. The system of claim 1, wherein the chamber comprises a thermal conductor along the warmed fluid channel and a thermal insulator along the cooled fluid channel.

6. The system of claim 1, wherein the coolant path comprises an inner and an outer wall, the inner wall providing fluid isolation between the warmed and cooled fluid channels.

7. The system of claim 6, wherein the outer wall comprises a thermal conductor.

8. The system of claim 6, wherein the inner wall defines a solid interior.

9. The system of claim 8, wherein the inner wall comprises a thermal insulator.

10. The system of claim 6, wherein the inner wall defines a hollow interior.

11. The system of claim 10, wherein the inner wall comprises a thermal conductor.

12. The system of claim 1, further comprising a sun-shield configured to shield at least a portion of the coolant path from the sun.

13. The system of claim 12, wherein the sun-shield is substantially thermally isolated from the coolant path.

14. The system of claim 13, further comprising at least one mount attaching the sun-shield to one of the channels, wherein the mount comprises a thermal insulator.

15. The system of claim 1, further comprising a radiator, thermally connected to the coolant path at a position substantially opposite the light source.

16. The system of claim 15, further comprising a sun-shield configured to shield at least a portion of the radiator from the sun.

17. The system of claim 1, wherein the coolant path is configured to compensate for volume changes in a coolant disposed in the coolant path.

18. The system of claim 17, wherein the coolant path comprises a coolant vent.

19. The system of claim 17, wherein the coolant path comprises at least one expandable portion, configured to adjust the volume of the coolant path to compensate for the volume changes in the coolant.

20. The system of claim 19, wherein the expandable portion comprises a patch comprising an elastic material.

21. The system of claim 19, wherein the expandable portion comprises a bellows.

22. The system of claim 1, further comprising coolant disposed in the coolant path, wherein the coolant comprises a member selected from the group consisting of water, deionized water, ethylene glycol, diethylene glycol, propylene glycol, and combinations thereof.

23. The system of claim 1, further comprising coolant disposed in the coolant path, wherein the coolant comprises a member selected from the group consisting of mineral oil, castor oil, silicone oil, fluorocarbon oil, and combinations thereof.

24. The system of claim 1, wherein the coolant path is defined by a member selected from the group consisting of copper, aluminum, copper alloy, aluminum alloy, and combinations thereof.

25. The system of claim 1, wherein the light source comprises at least one light-emitting diode.

26. The system of claim 25, wherein the light-emitting diode emits light that is substantially white in color.

27. An apparatus, comprising:
a chamber defining a closed-loop coolant path, the coolant path comprising a first channel for upward moving coolant and a second channel for downward moving coolant, each channel comprising a top and a bottom end, wherein the top ends of the channels are in fluid communication, and the bottom ends of the channels are in fluid communication; and
a light source, thermally connected to the chamber at a position along the first channel.

28. The apparatus of claim 27, wherein the light source is disposed near the bottom end of the first channel.

29. An apparatus, comprising:
a chamber defining a closed loop coolant path, the coolant path comprising a first channel for upward moving coolant at a first side of the chamber and a second channel for downward moving coolant at a second side of the chamber, each channel comprising a top and a bottom end, wherein the top ends of the channels are in fluid communication, and the bottom ends of the channels are in fluid communication; and
a light source, thermally connected to the first side of the chamber.

30. The apparatus of claim 29, wherein the light source is disposed near the bottom end of the first channel.
